(19) United States
(12) Patent Application Publication
(10) Pub. No.: US 2001/0052509 A1
(43) Pub. Date: Dec. 20, 2001

(54) Method of manufacturing thin film magnetic head

(75) Inventor: Toru Katakura, Miyagi (JP)

Correspondence Address: David R. Metzger, Esq., SONNENSCHEIN NATH & ROSENTHAL, P.O. Box #061080, Wacker Drive Station, Sears Tower, Chicago, IL, 60606-1080, US

(73) Assignee: SONY CORPORATION

(21) Appl. No.: 09/879,679

(22) Filed: Jun. 12, 2001

(30) Foreign Application Priority Data
Jun. 16, 2000 (JP) P2000-185946

(51) Int. Cl. B44C 1/22

(52) U.S. Cl. 216/22

(57) ABSTRACT

The present invention discloses a method of manufacturing a magnetic head in which a magnetic yoke is formed on a substrate in parallel thereto by the thin film process, which comprises the steps of forming a yoke-patterned recess in a non-magnetic material layer formed on the substrate; and forming a magnetic yoke layer in such recess while forming a non-magnetic gap portion approximately normal to the substrate; wherein a split portion is provided to the gap portion so as to recess behind a level where a slide-contact plane with recording media is formed, which results in a magnetic head which can successfully prevent the noise generation over a long period, and can improve the playback efficiency.

### BACKGROUND OF THE INVENTION

1. Field of the Invention

The present invention relates to a method of manufacturing a yoke-type magnetic head of the slide-contact type or the flotation type, and in particular to a method of manufacturing a yoke-type, thin-film magnetic head of the magneto-resistive effect type or the inductive type which is mounted on a rotating drum of a magnetic head device based on a helical scan system using a magnetic tape as a recording medium.

2. Description of the Related Art

A magnetic head employed in a magnetic tape device using a magnetic tape as a recording medium, which is typified by an inductive-type magnetic head having a ferrite core, suffers from a problem that output of a reproducing signal tends to be lower in high-density recording, particularly for a case where a reproducing track width is reduced as narrow as 5 μm or below. One measure for addressing such problem relates to a magnetic head having as a reproducing head a magneto-resistive effect element (MR element) or a spin valve element. Such magnetic head is provided so as to align the MR element at a plane which is brought into slide-contact with the magnetic tape, and so as to direct the magnetic gap in parallel to the substrate.

Such a conventional magnetic head, however, causes time-dependent abrasion due to friction of the magnetic head with magnetic tapes, and accordingly generates noise due to changes in device morphology and thermal asperity, since the magneto-resistive effect device is provided at the slide-contact plane with magnetic tapes. Another problem resides in that the reproducing efficiency is intrinsically low since the magnetic gap is aligned in parallel to the substrate.

### SUMMARY OF THE INVENTION

The present invention is accomplished considering the foregoing situation, and it is therefore an object of the present invention is to provide a method of manufacturing a magnetic head capable of avoiding the noise generation over a long period and improving the reproducing efficiency.

Such object of the present invention will be accomplished by a method of manufacturing a magnetic head in which a magnetic yoke is formed on a substrate in parallel thereto by a thin film process, comprising the steps of forming a yoke-patterned recess in a non-magnetic material layer formed on the substrate; and forming a magnetic yoke layer in the yoke-patterned recess while forming a non-magnetic gap portion approximately perpendicular to the substrate; wherein a split portion is provided to the gap portion so as to recess behind a level where a slide-contact plane with recording media is formed.

In such constitution, a magneto-resistive effect device is provided as being recessed deep into the yoke-type magnetic head structure to thereby make it less susceptible to the morphological changes in the device structure or thermal asperity, which successfully prevents the noise generation over a long period. Moreover, possibility in the downsizing of a magnetic circuit will improve the reproducing efficiency.

### BRIEF DESCRIPTION OF THE DRAWINGS

The above and other objects, features and advantages of the present invention will become more apparent from the following description of the presently preferred exemplary embodiments of the invention taken in conjunction with the accompanying drawings, in which:

FIG. 1 is a perspective view showing an embodiment of a magnetic head fabricated in accordance with the present invention;

FIG. 2 is a schematic perspective view showing a process step for manufacturing the magnetic head shown in FIG. 1;

FIG. 3 is a schematic perspective view showing a process step as continued from FIG. 2;

FIGS. 4A and 4B are a schematic perspective view and a sectional view, respectively, showing a process step as continued from FIG. 3;

FIG. 5 is a schematic perspective view showing a process step as continued from FIGS. 4A and 4B;

FIG. 6 is a schematic perspective view showing a process step as continued from FIG. 5;

FIG. 7 is a schematic perspective view showing a process step as continued from FIG. 6;

FIG. 8 is a schematic perspective view showing a process step as continued from FIG. 7;

FIGS. 9A and 9B are a schematic perspective view and a sectional view, respectively, showing a process step as continued from FIG. 8;

FIGS. 10A and 10B are a schematic perspective view and a sectional view, respectively, showing a process step as continued from FIG. 9;

FIG. 11 is a schematic perspective view showing a process step as continued from FIGS. 10A and 10B;

FIG. 12 is a schematic perspective view showing a process step as continued from FIG. 11;

FIG. 13 is a schematic perspective view showing a process step as continued from FIG. 12;

FIG. 14 is a schematic perspective view showing a process step as continued from FIG. 13;

FIG. 15 is a schematic perspective view showing a process step as continued from FIG. 14;

FIG. 16 is a schematic perspective view showing a process step as continued from FIG. 15;

FIG. 17 is a schematic perspective view showing a process step as continued from FIG. 16;

FIG. 18 is a schematic perspective view showing a process step as continued from FIG. 17;

FIG. 19 is a schematic perspective view showing a process step as continued from FIG. 18;

FIGS. 20A to 20E are schematic views showing a first method of manufacturing the yoke core of the magnetic head shown in FIG. 1;

FIGS. 21A to 21G are schematic view showing a first method as continued from FIG. 20E;

FIGS. 22A to 22F are schematic view showing a second method of manufacturing the yoke core of the magnetic head shown in FIG. 1;

FIGS. 23A to 23G are schematic views showing a second method as continued from FIG. 22F;

FIGS. 24A to 24F are schematic view showing a third method of manufacturing the yoke core of the magnetic head shown in FIG. 1;

FIGS. 25A to 25F are schematic views showing a third method as continued from FIG. 24F;

FIGS. 26A to 26G are schematic views showing a third method as continued from FIG. 25F;

FIGS. 27A to 27G are schematic views showing a fourth method for manufacturing a yoke core of a magnetic head shown in FIG. 1;

FIGS. 28A to 28D are schematic views showing a fourth method as continued from FIG. 27G;

FIG. 29 is a perspective view showing an exemplary magnetic head device mounted with the magnetic head shown in FIG. 1; and

FIG. 30 is a plan view showing an exemplary magnetic tape device having the magnetic head device shown in FIG. 29.

### DESCRIPTION OF THE PREFERRED EMBODIMENT

Preferred embodiments of the present invention will be explained hereinafter referring to the attached drawings.

It should now be noted that although the specific embodiments described below, which are most preferable ones of the present invention, will be provided with various limitations in view of technical preference, the scope of the present invention is by no means limited thereto unless otherwise the description for limiting the present invention is specifically given.

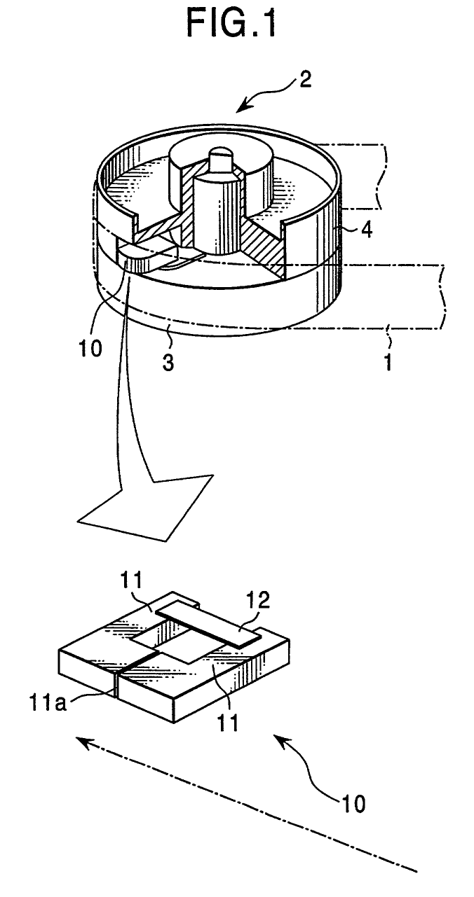

FIG. 1 is a perspective view showing an embodiment of a magnetic head fabricated in accordance with the present invention.

A magnetic head 10 shown in FIG. 1 is a yoke-type thin-film MR head mounted on a rotating drum 4 rotating on a fixed drum 3 of a magnetic head device 2 of the helical scan system, with which a magnetic tape 1 is used as a recording medium.

The magnetic head 10 comprises a yoke core 11 having a magnetic gap 11a exposed to the magnetic tape slide-contact plane, and an MR element or GMR element 12 formed on the yoke core 11 in an integrated manner therewith at the end opposite to such magnetic tape slide-contact plane; which are formed on a wafer substrate. The magnetic gap 11a of the yoke core 11 is formed so as to be aligned not in parallel to the wafer substrate plane (head moving direction), for example approximately perpendicular thereto.

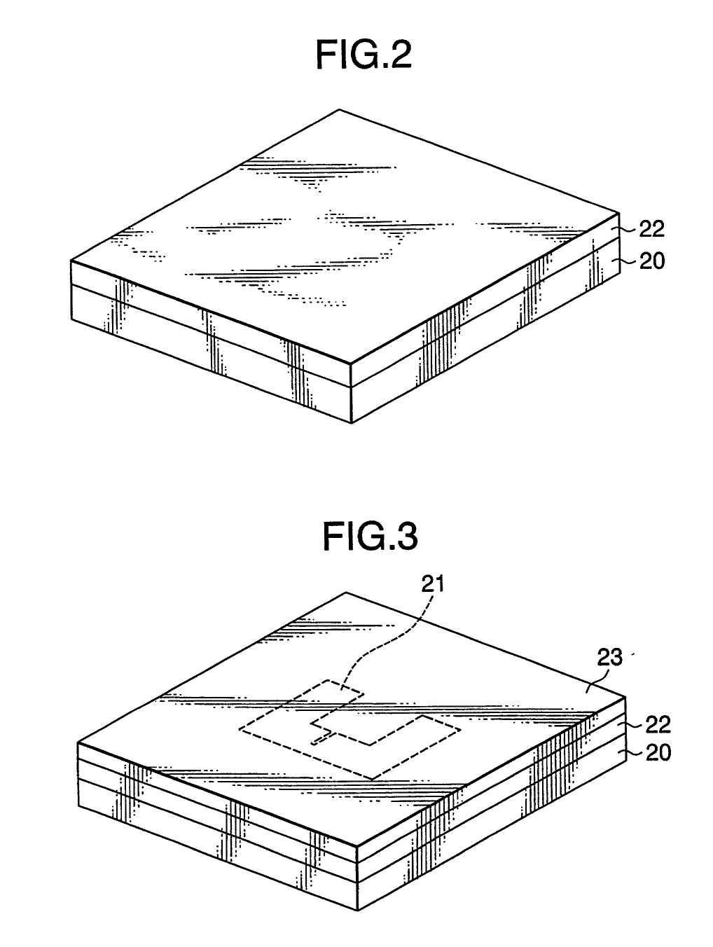

FIGS. 2 to 19 are schematic views showing a method of manufacturing the magnetic head 10 shown in FIG. 1. It should now be noted that some of the drawings show only an enlarged characteristic portion for easy recognition, so that dimensional ratios of individual components illustrated in these drawings do not always comply with the actual ratios.

First, on a wafer substrate 20 made of highly abrasion-resistant calcium titanate (CaTiO₃) or AlTiC (alumina-titanium carbide) (Al₂O₃—TiC), a film 22 for forming yoke core groove comprising a chromium (Cr) film, a silicon dioxide (SiO₂) film and a chromium (Cr) film stacked in this order is formed using a sputtering apparatus (FIG. 2). The upper chromium (Cr) film is formed in a thickness of 100 nm, which is provided as an etching mask used when the silicon dioxide (SiO₂) film of 1.7 μm thick is anisotropically etched using a reactive ion etching (RIE) apparatus.

The upper chromium (Cr) film has a selectivity with regard to the silicon dioxide film of 40 or above after an anisotropic etching, which is substitutable with an amorphous alloy film such as CoZrNb film.

The lower chromium (Cr) film has a thickness of 50 nm, which is provided to limit the etching amount of the silicon dioxide (SiO₂) film and to relief the surface roughness of the wafer substrate 20 before it is fabricated into a head.

Next, on the entire surface of the film 22, an electron beam resist layer 23 (for example, ZEP 520(12), a product of Zeon Corporation) is formed by spin-coating at 2,000 rpm using a spin coating apparatus and cured, which is followed by drawing of a mask pattern 21 for forming the yoke core 11 using an electron beam drawing apparatus (FIG. 3).

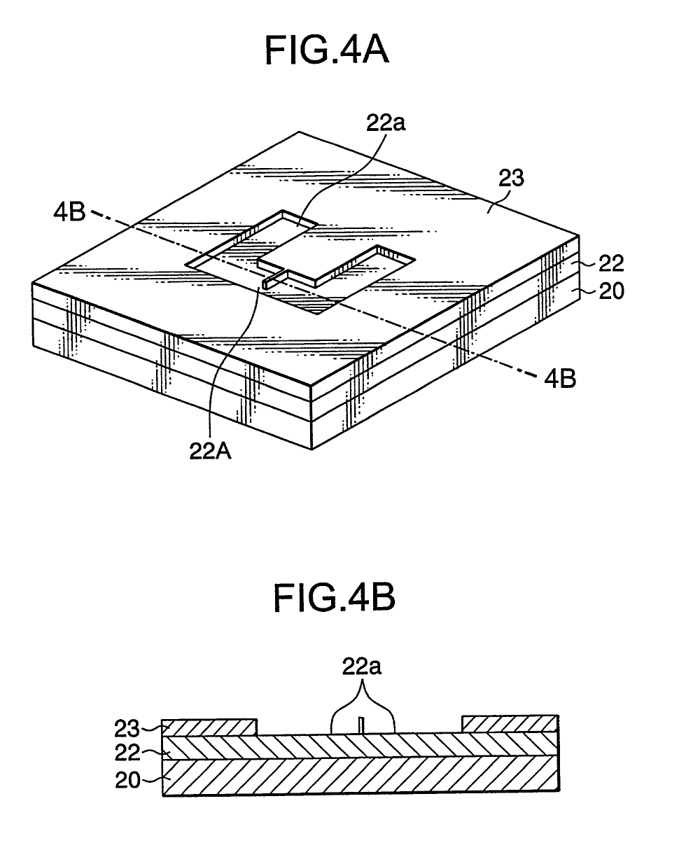

Next, the electron beam resist layer 23 is developed to thereby form the mask pattern 21, and a portion of the upper chromium (Cr) film exposed in the opening of such mask pattern 21 is then etched with argon (Ar) ion using an ion etching apparatus, to thereby form a mask 22a having an opening for forming the yoke core 11 (FIG. 4).

The mask 22a now has a split portion 22A which is given so as to split a part of the portion for forming the magnetic gap 11a and so as to recess behind a level where a slide-contact plane with recording media is formed. A reason for forming the mask 22a having such split portion 22A will be detailed later.

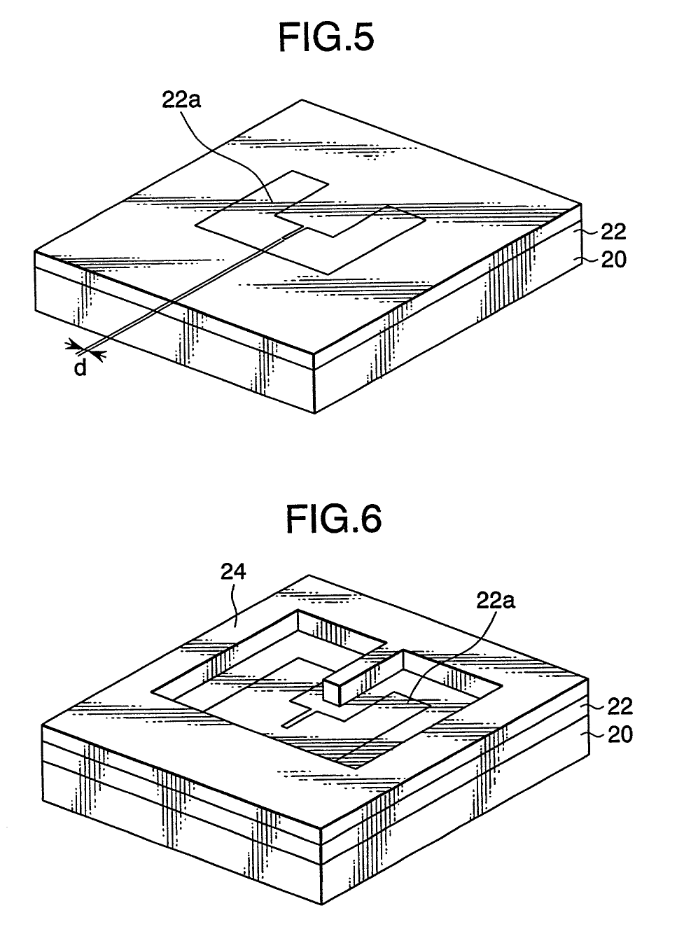

Thereafter the electron beam resist layer 23 is removed, although being not always necessary. The mask 22a for forming the yoke core 11 now has a width d of the split portion 22A (corresponding to the gap width) of, for example, 0.2 μm (FIG. 5).

Next, a novolak-base, g-line resist layer 24 (for example, AZ-4400, a product of Hoechst AG) is formed by coating so as to cover the area other than the opening of the mask 22a for forming the yoke core 11, and cured at 90 to 120° C. The novolak-base, g-line resist layer 24 is now patterned so as to have an opening larger by 1 to 10 μm than the opening of the mask 22a (FIG. 6). The novolak-base, g-line resist layer 24 is aimed at preventing polymer deposition which possibly inhibits the etching performed in the next process step using an RIE apparatus, and use thereof is optional.

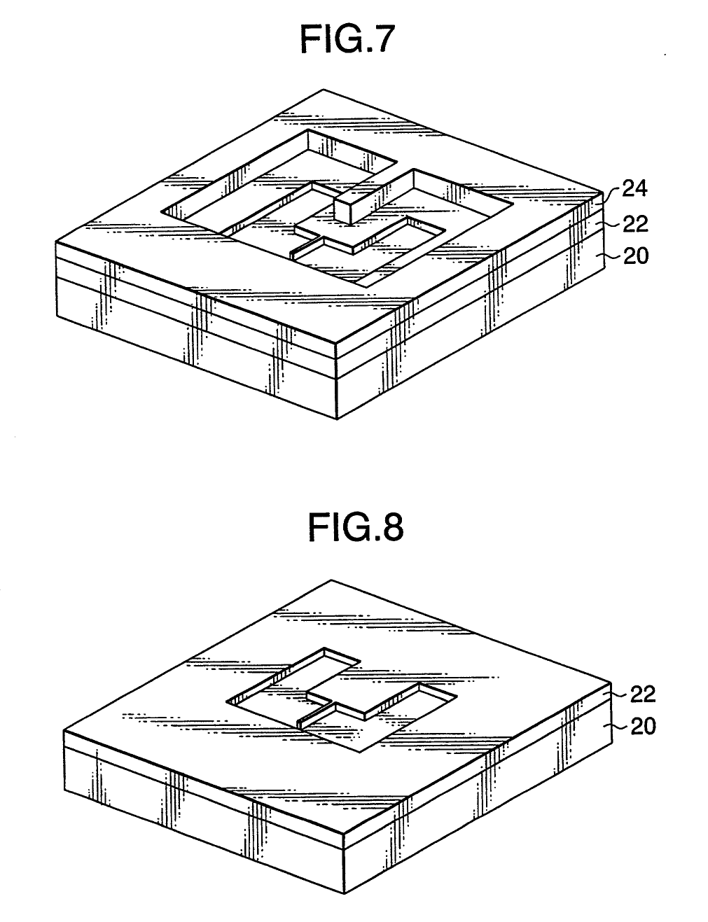

Next, the silicon dioxide (SiO₂) film exposed in the opening of the mask 22a for forming the yoke core 11 is anisotropically etched using an RIE apparatus until the lower chromium (Cr) film appears. Etching gas employed herein is a tetrafluorocarbon (CF₄) gas or a mixed gas of tetrafluorocarbon (CF₄) gas and oxygen (O₂), the etching power is set low so as to prevent undesirable temperature rise in the surface, and the etching time is set longer by approx. 10 to 20% than the time theoretically required for etching an SiO₂ film of 1.7 μm thick (FIG. 7). Since the etching stops on the surface of the lower chromium (Cr) film in the film 22, the surface roughness of the wafer substrate 20 is reproduced. This is followed by removal of the novolak-base, g-line resist layer 24 (FIG. 8).

Now a reason why the mask 22 is provided with the foregoing split portion 22A will be discussed. During the etching using the RIE apparatus, the temperature of the mask 22a made of the chromium (Cr) film will gradually rise due to the exposure to the etching plasma. In particular for a case where the pattern width of the silicon dioxide film (SiO₂) is 0.3 μm or below, and the thickness to be etched amounts to 1 μm or above, the temperature of the mask 22a becomes considerably higher since the heat radiation will be expectable only from a limited area of silicon dioxide (SiO₂) just below the mask 22a.

Thus in the portion for forming the magnetic gap 11a, where the mask 22a has only a very small width, the upper chromium (Cr) film may deform due to heat expansion, and may even peel off from the silicon dioxide (SiO₂) film to thereby break in the worst case, which cannot serve as a mask any more. One possible measure for solving such problem relates to intermittent etching, in which a five-minute etching and three-minute cooling, for example, are alternated. This, however, results in that a larger part of the etching is proceeded in the fluctuating plasma, which makes it difficult to obtain the magnetic gap having an exact shape, and in particular to form the silicon dioxide (SiO₂) into a pattern having a width of 0.3 μm or below and a height of 1 μm or above, and which also makes it time-consuming.

In the present invention, the mask 22a is formed so as to be partially split at the portion for forming the magnetic gap 11a to thereby have a discontinued structure, which successfully absorb the thermal expansion and thus prevents the upper chromium (Cr) film from being deformed, peeled-off from the silicon dioxide (SiO₂) and broken. Since the split portion 22A is provided to the gap portion so as to recess behind a level where a slide-contact plane with recording media is formed, so that the split portion 22A will not adversely affect a final product of the magnetic head 10 finished by surface grinding.

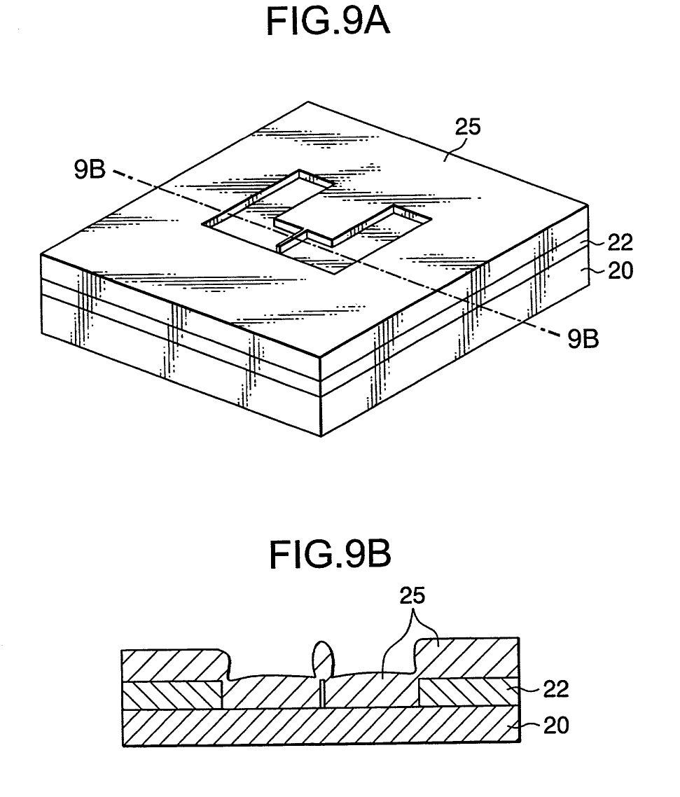

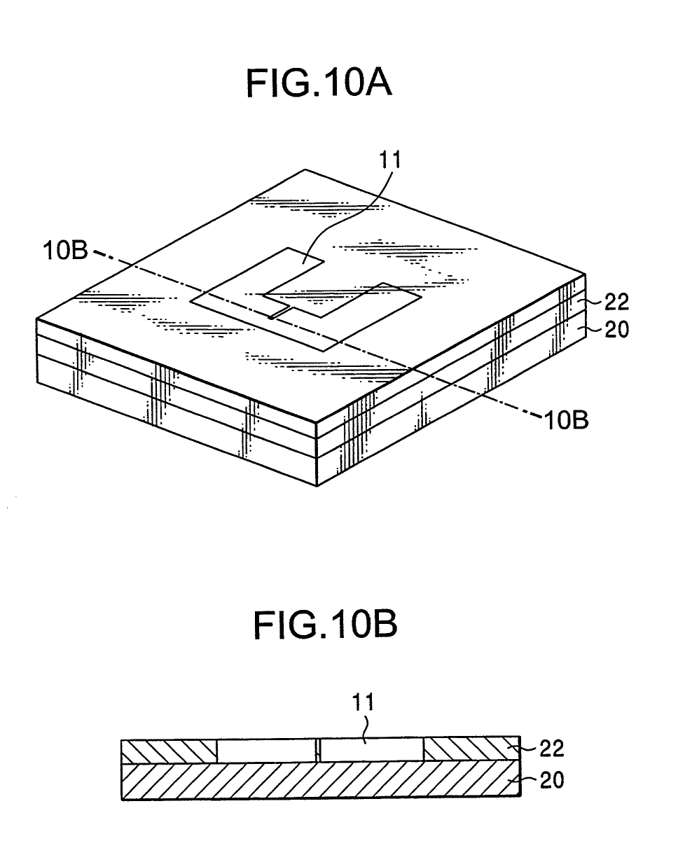

Next, on the upper chromium (Cr) film and the lower chromium (Cr) exposed by the anisotropic etching, a magnetic layer 25 for forming the yoke core 11 is formed using a collimation apparatus, an RF-bias sputtering apparatus or a plating apparatus (FIGS. 9A and 9B). The magnetic layer 25 in this process step is formed in a predetermined thickness on the upper and lower chromium (Cr) layers as shown in FIG. 9B which is a sectional view taken along the line A-A in FIG. 9A. The top surface of the magnetic layer 25 is then planarized by polishing using a buffing machine to have the yoke core 11 to be a predetermined thickness, typically to 1.5 μm (FIGS. 10A and 10B).

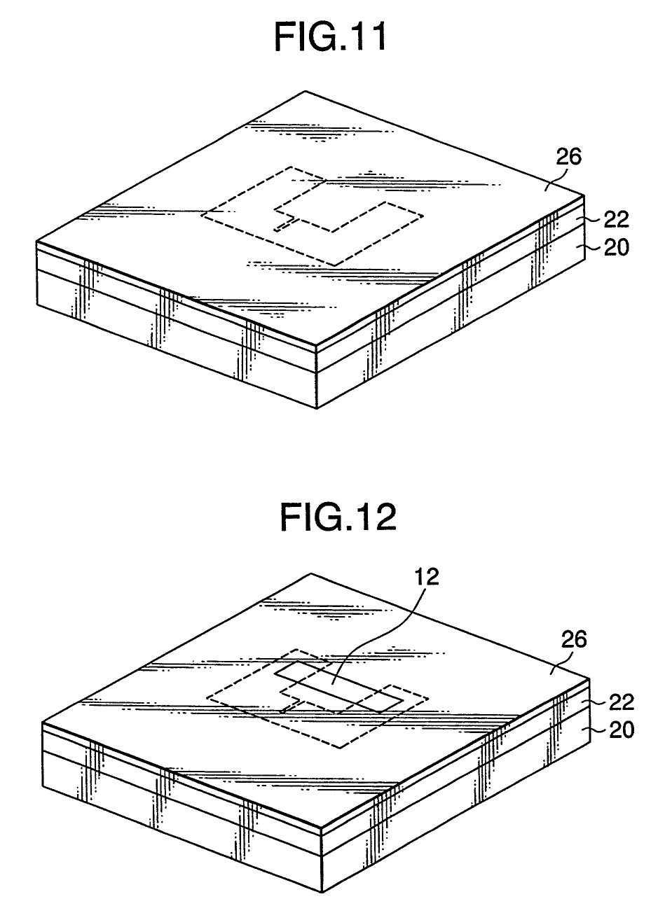

Next, on the entire surface of the film 22 and the yoke core 11, an insulating film 26 made of silicon dioxide (SiO₂) or aluminum oxide (Al₂O₃), which is provided for ensuring insulation between the yoke core and the MR element or GMR element 12, is formed using a sputtering apparatus. The top surface of the insulating film 26 is then planarized by polishing using a buffing machine (FIG. 11), and the MR element or GMR element 12 is formed on the yoke core 11 at the end opposite to the magnetic tape slide-contact plane (FIG. 12).

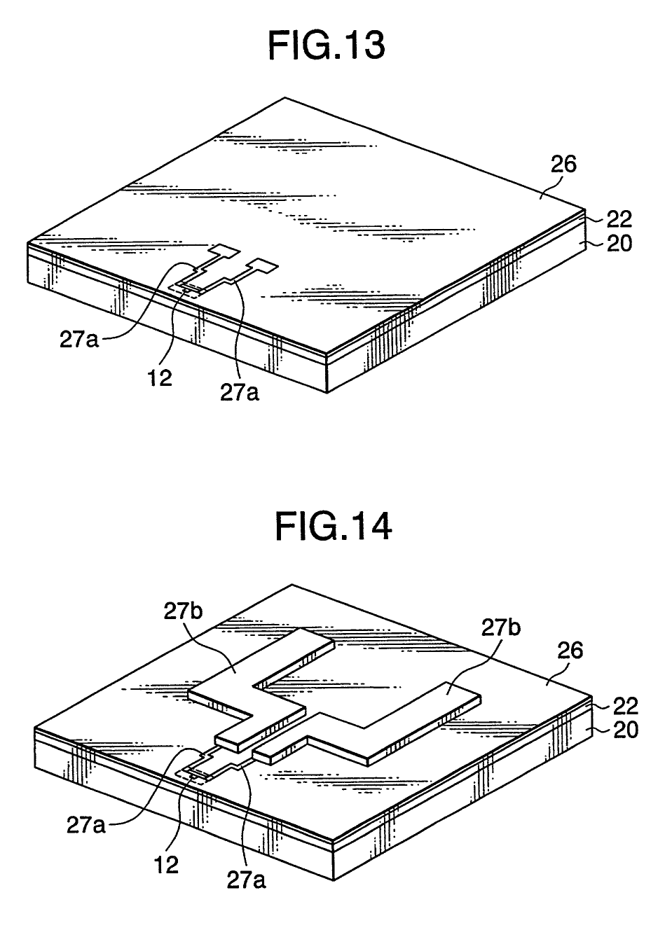

Next, the a first electrode 27a and a second electrode 27b are formed based on sputtering and the successive lift-off processes, and terminals 28 individually connected thereto are formed using a plating apparatus. A layout of the first electrode 27a, second electrode 27b and terminals 28 is such that shown in FIGS. 13, 14 and 15, all of which showing an entire portion of the wafer substrate 20. The description below relates to the entire portion of the wafer substrate 20.

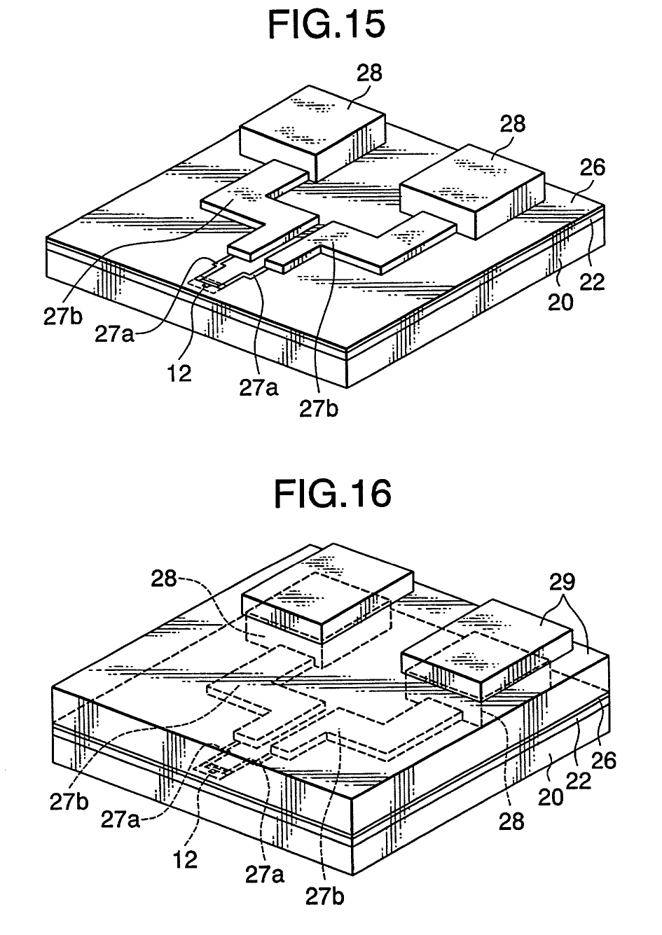

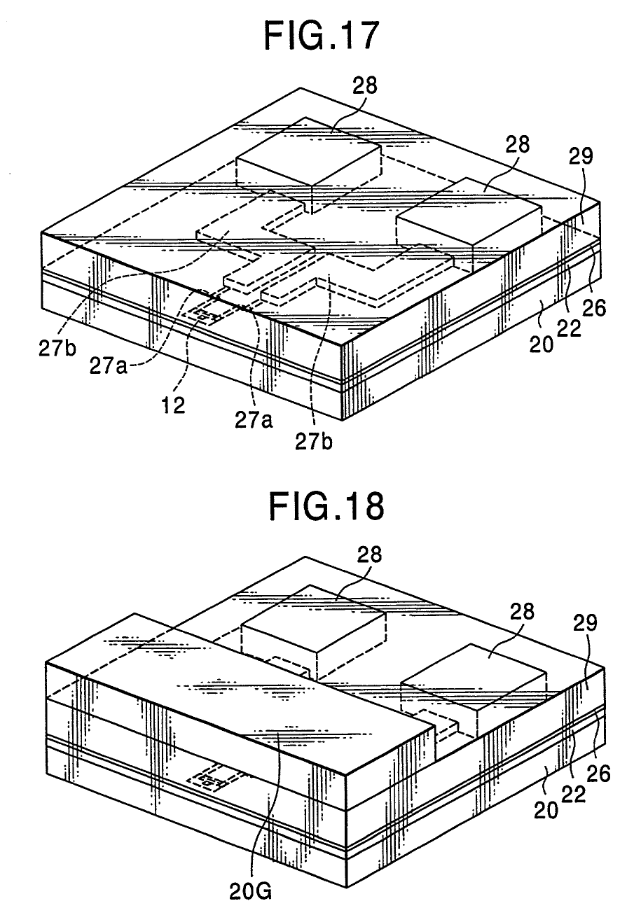

Next, a protective layer 29 made of silicon dioxide (SiO₂) or aluminum oxide (Al₂O₃) is formed using an RF-bias sputtering apparatus on the entire surface of the film 22, the MR element or GMR element 12, the first electrode 27a, the second electrode 27b, and the terminals 28 (FIG. 16). The top surface of the protective layer 29 is then planarized by polishing using a mechanical polishing machine to thereby expose the top surface of the terminals 28 and ensure the entire flatness (FIG. 17).

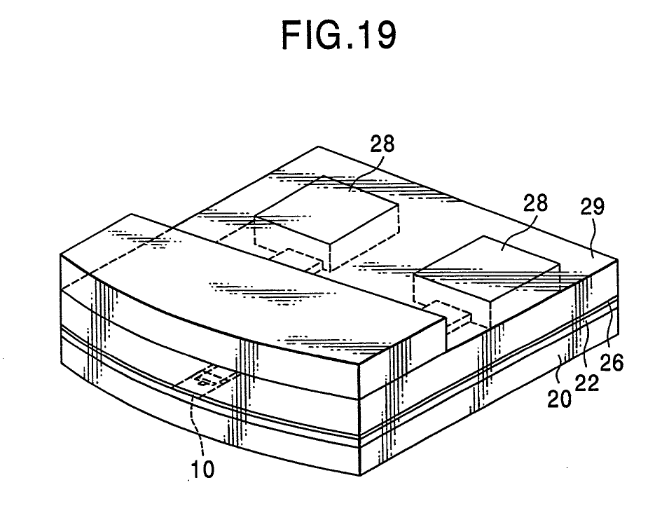

In the final step, on the protective layer 29 and within a portion over the MR element or GMR element 12, an upper guard member 20G made of calcium titanate (CaTiO₃) or AlTiC (alumina-titanium carbide) (Al₂O₃—TiC) is adhered (FIG. 18), and the magnetic tape slide-contact plane is finished using a cylindrical polishing machine, to thereby complete the final product of the magnetic head 10 (FIG. 19).

While the above embodiment dealt with the yoke-type thin-film MR head, the present invention is by no means limited thereto, and is applicable also to an inductive head in which a core aligned in parallel to the major plane of the wafer substrate 20 and an electro-magnetic conversion coil are integrated with the yoke core 11, or to a recording/reproducing magnetic head integrated therewith. Also the method of manufacturing the yoke core 11 is not limited to that described in the above, and instead the methods described below are also allowable.

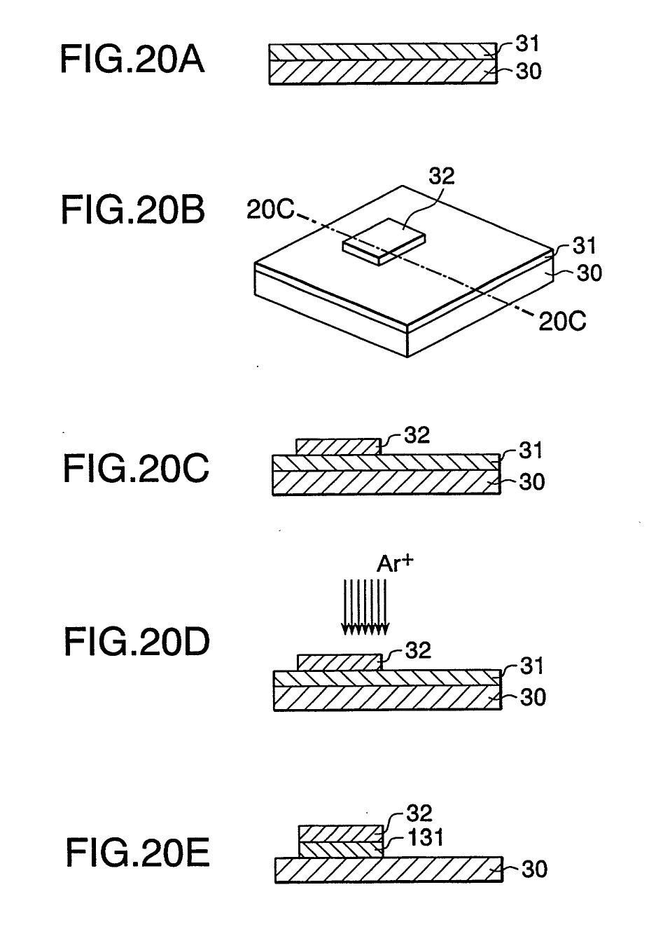

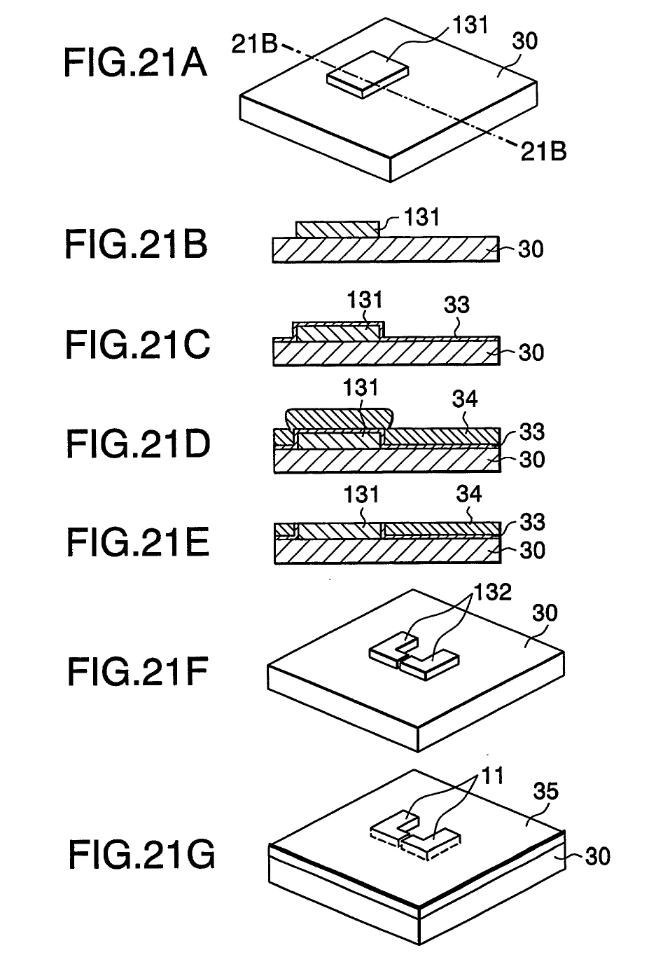

FIGS. 20A to 21F are schematic views showing a first method for manufacturing the yoke core 11, in which the magnetic gap 11a is provided perpendicular to a wafer substrate 30.

First, on the entire surface of the wafer substrate 30 a magnetic layer 31 is formed using a sputtering apparatus (FIG. 20A), and on the magnetic layer 31 a resist layer 32 for forming a magnetic portion 131 corresponding to one half of the yoke core 11 is formed using a printing machine, and then cured (FIGS. 20B and 20C). The exposed portion of the magnetic layer 31 is then etched using an ion etching apparatus (FIGS. 20D and 20E), and the resist layer 32 is removed to thereby form the magnetic portion 131 as the one half of the yoke core 11 (FIGS. 21A and 21B).

Next, on the magnetic portion 131 as the one half of the yoke core 11 and the wafer substrate 30, a gap layer 33 is formed using a sputtering apparatus (FIG. 21C), and further thereon, a magnetic layer 34 is formed using a sputtering apparatus (FIG. 21D).

Then the top surface of the magnetic layer 34 is planarized by polishing using a mechanical polishing machine, where the gap layer 33 is locally removed in a portion on the top surface of the magnetic portion 131 as the one half of the yoke core 11 (FIG. 21E). Then the magnetic portion 131 as the one half of the yoke core 11, the gap layer 33 and the magnetic layer 34 are patterned using an ion etching apparatus to thereby form an outline portion 132 of the yoke core 11 (FIG. 21F).

In the final step, an insulating layer 35 is formed on the entire surface of the wafer substrate 30 so as to fully cover the outline portion 132 of the yoke core 11, and a top surface of the insulating layer 35 is then planarized by polishing using a mechanical polishing machine until the thickness of the outline portion 132 is reduced to a predetermined value (FIG. 21G). Such processes successfully provide the yoke core 11.

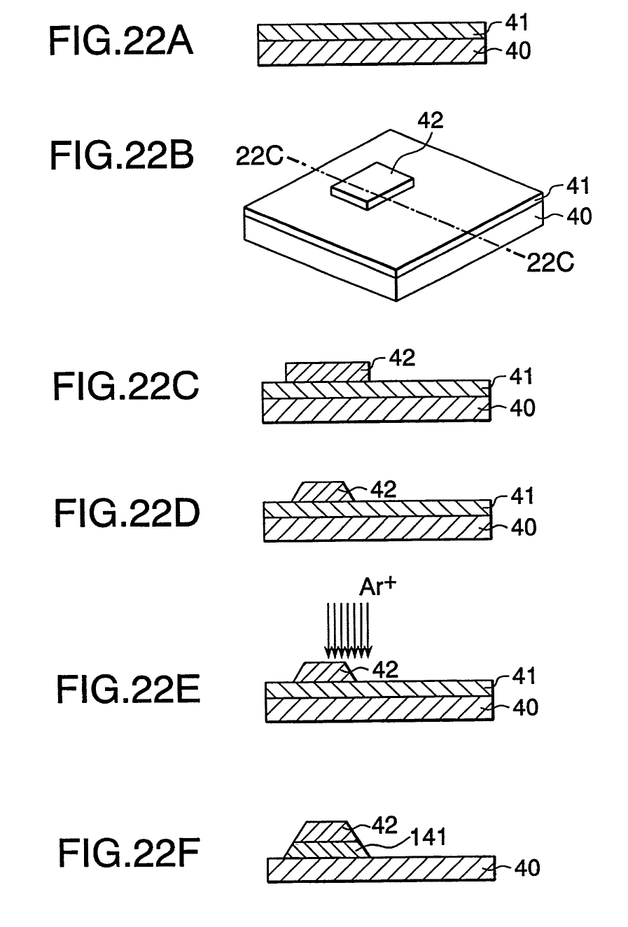

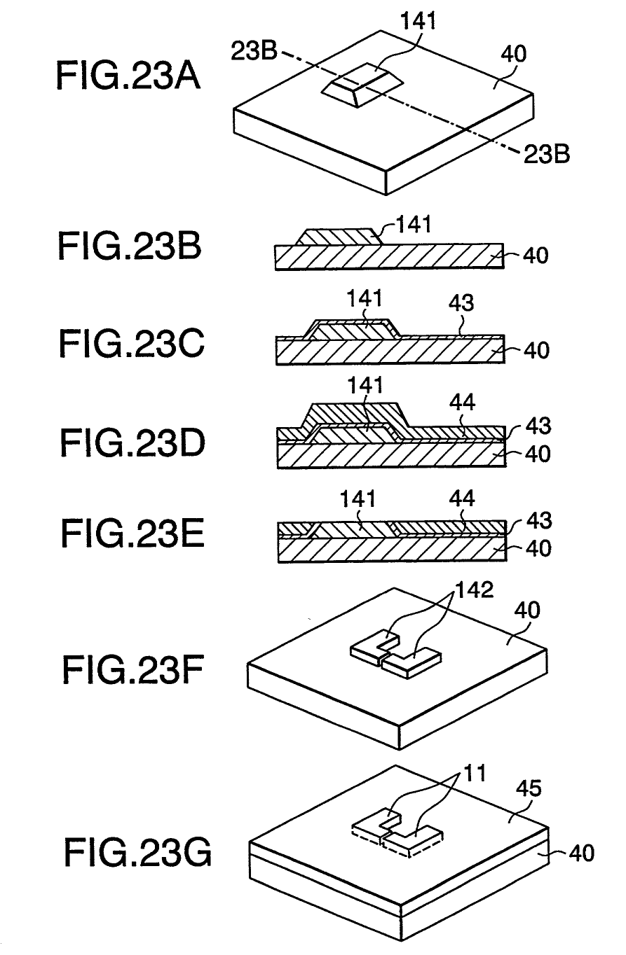

FIGS. 22A to 23G are schematic views showing a second method for manufacturing the yoke core 11, in which the magnetic gap 11a is provided inclined to a wafer substrate 40.

First, on the entire surface of the wafer substrate 40 a magnetic layer 41 is formed using a sputtering apparatus (FIG. 22A), and on the magnetic layer 41, a resist layer 42 for forming a magnetic portion 141 corresponding to one half of the yoke core 11 is formed using a printing machine, and then cured to thereby produce a mesa-formed pattern (FIGS. 22B, 22C and 22D). The exposed portion of the magnetic layer 41 is then etched using an ion etching apparatus (FIG. 22E), to thereby form a mesa-formed magnetic portion 141 as the one half of the yoke core 11 (FIG. 22G).

Next, the resist layer 42 is removed (FIGS. 23A and 23B), and a gap layer 43 is formed using a sputtering apparatus on the magnetic portion 141 as the one half of the yoke core 11 and the wafer substrate 40 (FIG. 23C), and further thereon, a magnetic layer 44 is formed using a sputtering apparatus (FIG. 23D).

Then the top surface of the magnetic layer 44 is planarized by polishing using a mechanical polishing machine, where the gap layer 43 is locally removed in a portion on the top surface of the magnetic portion 141 as the one half of the yoke core 11 (FIG. 23E). Then the magnetic portion 141 as one half of the yoke core 11, the gap layer 43 and the magnetic layer 44 are patterned using an ion etching apparatus to thereby form an outline portion 142 of the yoke core 11 (FIG. 23F).

In the final step, an insulating layer 45 is formed on the entire surface of the wafer substrate 40 so as to fully cover the outline portion 142 of the yoke core 11, and a top surface of the insulating layer 45 is then planarized by polishing using a mechanical polishing machine until the thickness of the outline portion 142 is reduced to a predetermined value (FIG. 23G). Such processes successfully provide the yoke core 11.

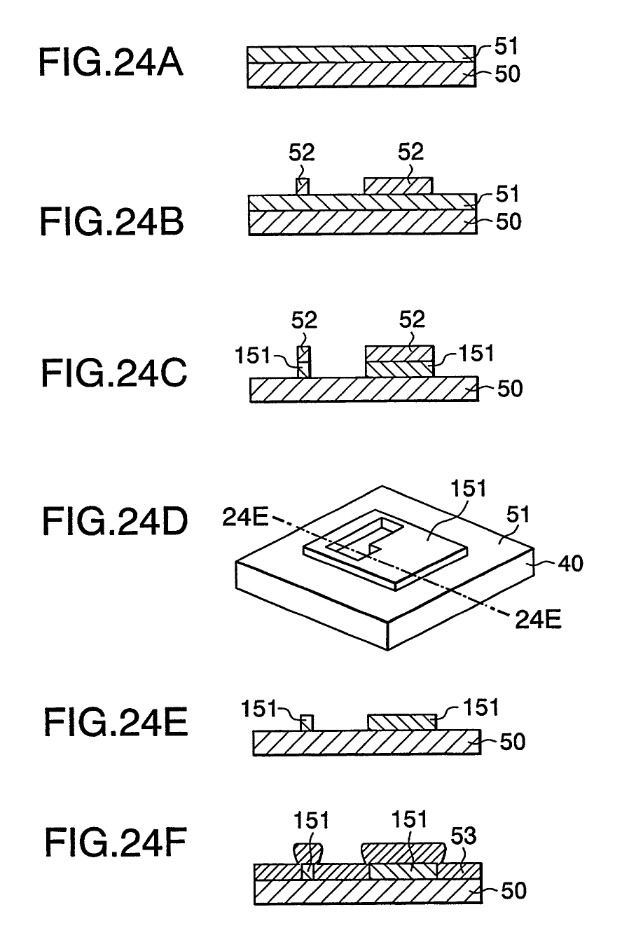

FIGS. 24A to 26G are schematic views showing a third method for manufacturing the yoke core 11.

First, on a wafer substrate 50, a film 51 comprising a chromium (Cr) film, a silicon dioxide (SiO₂) film and a chromium (Cr) film stacked in this order is formed using a sputtering apparatus (FIG. 24A), and further thereon, a resist layer 52 is formed using a printing machine and then cured to thereby produce a mask used for processing one half of the yoke core 11 (FIG. 24B).

The exposed portion of the upper chromium (Cr) film in the film 51 is then etched using an ion etching apparatus, and then the exposed silicon dioxide (SiO₂) film is anisotropically etched until the lower chromium (Cr) layer exposes (FIG. 24C). The resist layer 52 is then removed to thereby produce a film portion 151 for forming the yoke core 11 (FIGS. 24D and 24E).

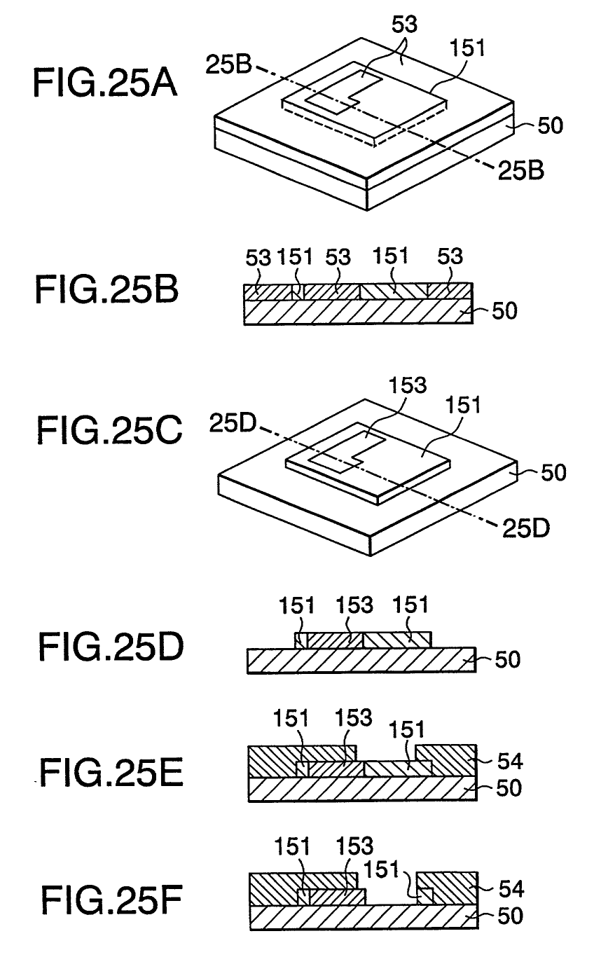

Next, on the wafer substrate 50 and the film portion 151, a magnetic layer 53 is formed using a sputtering apparatus (FIG. 24F), and a top surface of the magnetic layer 53 is then planarized by polishing using a mechanical polishing machine until a top surface of the film portion 151 exposes (FIGS. 25A and 25B). Then the magnetic layer 53 around the film portion 151 is removed using a wet etching apparatus, to thereby form a magnetic portion 153, as the one half of the yoke core 11, as being surrounded by the film portion 151 (FIGS. 25C and 25D).

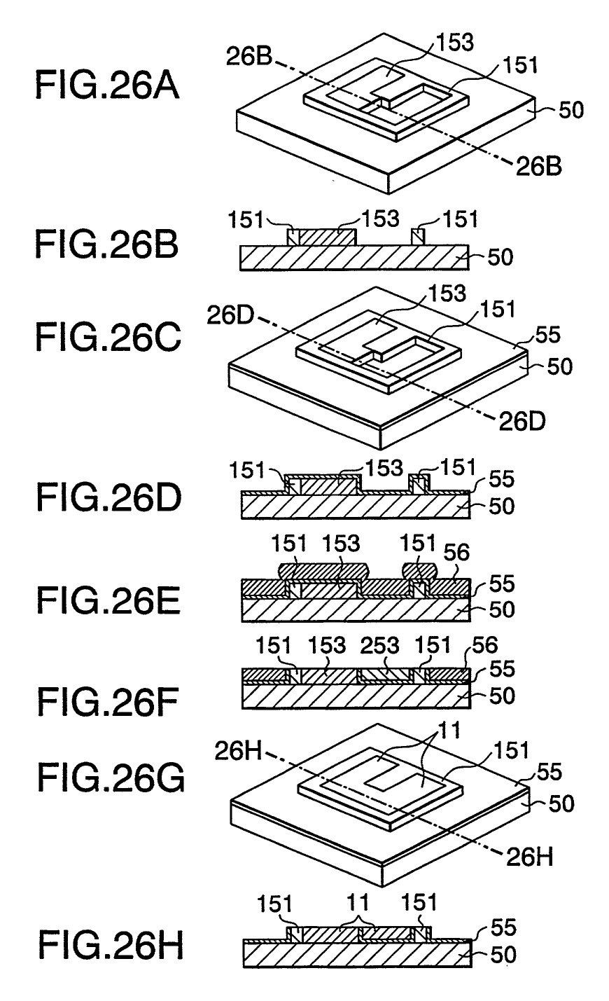

Next, on the wafer substrate 50, the film portion 151 and the magnetic portion 153, a resist layer 54 is formed using a printing machine and cured, to thereby produce a mask used for processing the other half of the yoke core 11 (FIG. 25E), and the exposed portion of the film portion 151 is then anisotropically etched using an RIE apparatus (FIG. 25F). The resist layer 54 is then removed (FIGS. 26A and 26B), a gap layer 55 is formed on the wafer substrate 50, the film portion 151 and the magnetic portion 153 using a sputtering apparatus (FIGS. 26C and 26D), and further thereon a magnetic layer 56 is formed (FIG. 26E).

In the final step, a top surface of the magnetic layer 56 is planarized by polishing using a mechanical polishing machine until the top surfaces of the film portion 151 and the magnetic portion 153 appear, to thereby form a magnetic portion 253 as the other half of the yoke core 11 surrounded by the film portion 151 (FIG. 26F). The magnetic layer 56 surrounding the film portion 151 is then removed using a wet etching apparatus, to thereby form the yoke core 11 (FIGS. 26G and 26H).

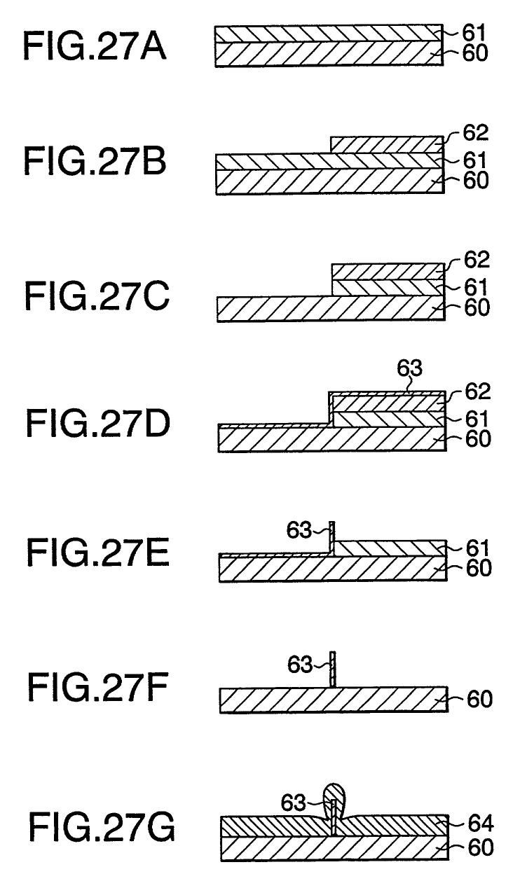

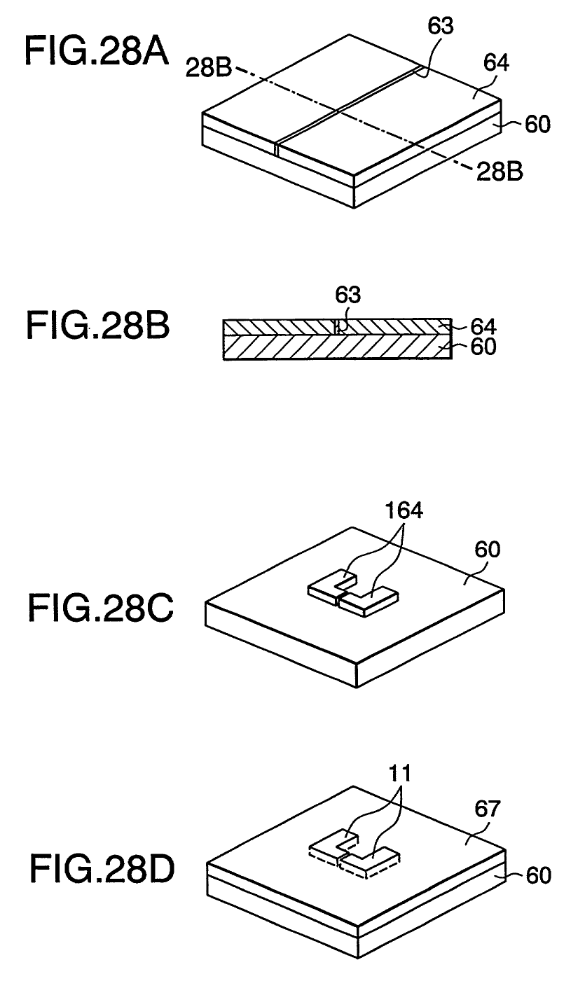

FIGS. 27A to 28D are schematic views showing a fourth method for manufacturing the yoke core 11.

First, on a wafer substrate 60, a film 61 comprising a silicon dioxide film (SiO₂) and a chromium (Cr) film stacked in this order is formed using a sputtering apparatus (FIG. 27A), and on approximately half area of a surface of such film 61, a resist layer 62 is formed using a printing machine and then cured to thereby produce a mask used for processing the gap 11a of the yoke core 11 (FIG. 27B).

The exposed portion of the film 61 is then etched using an etching apparatus (FIG. 27C), a gap layer 63 is formed on the wafer substrate 60 and the resist layer 62 using a sputtering machine (FIG. 27D). A portion of the gap layer 63 on the resist layer 62 is then removed together with such resist layer 62 by the lift-off process (FIG. 27E), and the film 61 and the horizontal portion, other than the vertical central portion, of the gap layer 62 is then anisotropically etched using an RIE apparatus (FIG. 27F).

Next, a magnetic layer 64 is formed on the wafer substrate 60 and the gap layer 63 using a sputtering apparatus (FIG. 27G), a top surface of such magnetic layer 64 is then etched using an ion etching apparatus (FIGS. 28A and 28B). The magnetic layer 64 is then patterned to produce a magnetic portion 164 having a shape of the yoke core 11 (FIG. 28C).

In the final step, an insulating layer 67 is formed on the wafer substrate 60 and the magnetic portion 164 using a sputtering apparatus, and a top surface of such magnetic layer 67 is planarized by polishing using a mechanical polishing machine until the top surface of the magnetic portion 164 exposes (FIG. 28D), to thereby produce the yoke core 11.

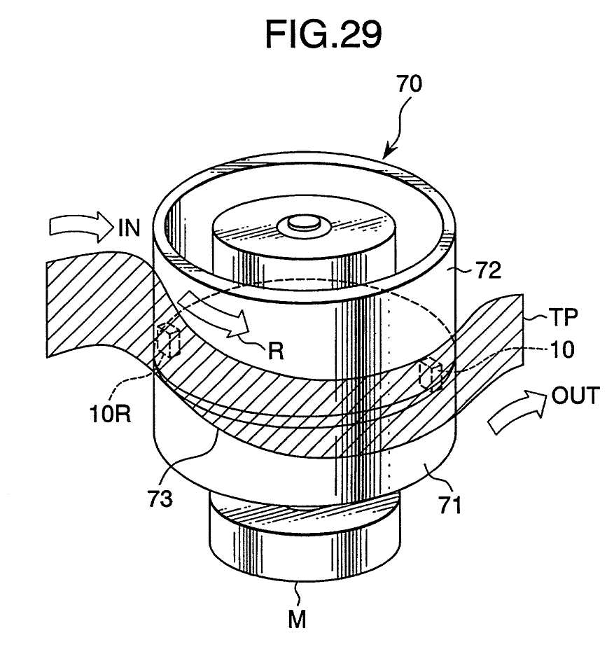

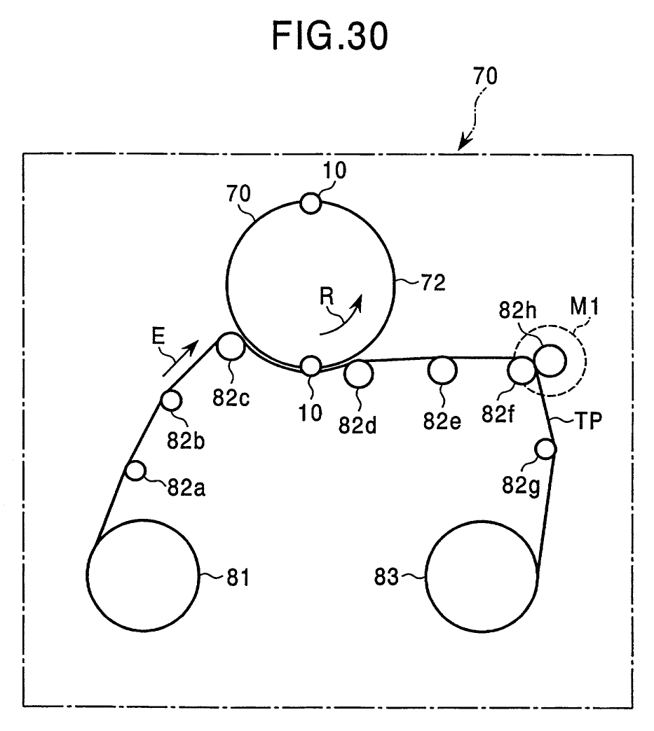

FIG. 29 is a perspective view showing an exemplary magnetic head device mounted with the magnetic head according to the embodiment of the present invention, and FIG. 30 is a plan view showing an exemplary magnetic tape device having such magnetic head device.

The magnetic head device 70 has a fixed drum 71, a rotating drum 72, a motor M and so forth, which refers to a rotating magnetic head device mounted to a magnetic tape device based on the helical scan system using a magnetic tape TP as an information recording medium. A magnetic tape device 80 is an information recording/reproducing device having the magnetic head device 70 therein.

As shown in FIG. 29, the rotating drum 72 is provided with a reproducing head 10 and a recording head 10R located at a phase difference of 180° . The rotating drum 72 rotates with the aid of the motor M in the direction indicated by the arrow R relative to the fixed head 71.

The magnetic tape TP is fed aslant from the entrance side IN, along the moving direction E as being guided by a lead guide portion 73 of the fixed drum 71 toward the exit side OUT. That is, as shown in FIG. 30, the magnetic tape TP is fed out from a supply reel 81, guided by rollers 82a, 82b and 82c, traverses on the fixed drum 71 in contact therewith over an angular range of approx. 180° as being guided by lead guide portion 73 thereof, and is further guided by rollers 82d, 82e, 82f and 82g to be taken up by a take-up reel 83.

Thus the reproducing head 10 and the recording head 10R traces on the magnetic tape TP according to the helical scan system. A capstan 82h is opposed to the roller 82f, and is rotated with the aid of a capstan motor M1.

Although the invention has been described in its preferred form with a certain degree of particularity, obviously many changes and variations are possible therein. It is therefore to be understood that the present invention may be practiced otherwise than as specifically described herein without departing from the scope and the sprit thereof.

For example, the present invention is not limited to the foregoing embodiment which dealt with an application to the magnetic head device based on the helical scan system, and is applicable to other types of the magnetic head device based on a fixed system allowing a high-speed sliding or flotation system.

What is claimed is:

1. A method of manufacturing a magnetic head in which a magnetic yoke is formed on a substrate in parallel thereto by a thin film process, comprising the steps of:
forming a yoke-patterned recess in a non-magnetic material layer formed on said substrate; and
forming a magnetic yoke layer in said yoke-patterned recess while forming a non-magnetic gap portion approximately perpendicular to said substrate; wherein a split portion is provided to said gap portion so as to recess behind a level where a slide-contact plane with recording media is formed.

2. The method of manufacturing a magnetic head as claimed in claim 1, wherein said non-magnetic material layer for composing the yoke-patterned recess formed on said substrate has at least a three-layered structure typically expressed as Cr/SiO₂/Cr.

3. The method of manufacturing a magnetic head as claimed in claim 1, wherein said non-magnetic material layer for composing the yoke-patterned recess formed on said substrate has at least a three-layered structure typically expressed as CoNbZr-base amorphous alloy/SiO₂/CoNbZr-base amorphous alloy
